(19) United States
(12) Patent Application Publication
(10) Pub. No.: US 2010/0013730 A1
(43) Pub. Date: Jan. 21, 2010

(54) ANTENNA ARRANGEMENT

(75) Inventor: Alexander AZHARI, Stockholm (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/175,828

(22) Filed: Jul. 18, 2008

(51) Int. Cl. H01Q 1/48; H01Q 1/38

(52) U.S. Cl. 343/848; 343/700 MS

(57) ABSTRACT

An antenna arrangement may include: a ground plane, a feed element, and a radiating element coupled to the feed element, the radiating element being substantially parallel to and vertically displaced from the ground plane by the feed element and a shortening element. The antenna may also include a conductive portion coupled to the ground plane using a switching element, the conductive portion being configured to alter the size of the ground plane.

### TECHNICAL FIELD

The present invention generally relates to antennas and, more particularly, to a semi-planar inverted F-antenna (PIFA) including a switching technology that may switch between, for example, GSM 850 and GSM 900, without affecting the High Band frequencies.

### BACKGROUND OF THE INVENTION

Wireless communication equipment, such as cellular and other wireless telephones, wireless network (WiLAN) components, GPS receivers, mobile radios, pagers, etc., use multi-band antennas to transmit and receive wireless signals in multiple wireless communication frequency bands. Consequently, one of the critical components of wireless devices is the antenna which should meet the demands of high performance in terms of high signal transmission strength, good reception of weak signals, increased (or narrowed, if required) bandwidth, and small dimensions.

Planar inverted F-antennas (PIFAs) have many advantages. They are easily fabricated, have a simple design, and cost little to manufacture. Currently, the PIFA is widely used in small communication devices, such as cellular phones. This is due to the PIFA's compact size that makes it easy to integrate into a device's housing, thereby providing a protected antenna. The PIFA also provides an additional advantage over, for example, the popular whip antennas with respect to radiation exposure. A whip antenna has an omnidirectional radiation field, whereas the PIFA has a relatively limited radiation field towards the user.

The PIFA is generally a λ/4 resonant structure and is implemented by short-circuiting the radiating element to the ground plane using a conductive wall, plate or post. Thus, the conventional PIFA structure consists of a conductive radiator or radiating element disposed parallel to a ground plane and is insulated from the ground plane by a dielectric material, typically air. This radiating element connects to two pins, typically disposed toward one end of the element, giving the appearance of an inverted letter “F” from the side view. The first pin electrically connects the radiating element to the ground plane, and the second pin provides the antenna feed. The frequency bandwidth, gain, and resonant frequency of the PIFA depend on the height, width, and depth of the conductive radiator element, and the distance between the first pin connected to the radiating element and ground, and the second pin connected to the antenna feed.

FIG. 2 illustrates a conventional PIFA 200 design. The conventional PIFA 200 includes a conductive plate which forms a radiating element 209 of the antenna. Radiating element 209 is disposed about parallel to a ground plane 210 formed on a substrate 211. This parallel orientation between radiating element 209 and ground plane 210 provides optimal performance, but other orientations are possible.

Radiating element 209 electrically connects to ground plane 210 via a tuning or shortening element 212, most often disposed at one side of radiating element 209 and a feed element 213. Feed element 213 is somewhat electrically insulated from ground plane 210. When electric current is fed to radiating element 209 mounted above ground plane 210 through feed element 213, radiating element 209 and ground plane 210 become excited and act as a radiating device.

The operating frequency or the resonance frequency of PIFA 200 can be modified either by adjusting the dimensions and shape of radiating element 209 or by moving the location of feed element 213 with respect to tuning element 212. The resonance frequency can also be finely adjusted by changing the height and/or width of tuning element 212. Thus, in the conventional PIFA, the operating frequency or resonance is fixed by the size, shape, or placement of feed element 213, tuning element 212, or radiating elements 209, respectively. To change the bandwidth of PIFA 200, the height must be increased which will lead to an undesirable increase in the overall antenna size.

Currently, various frequency bandwidths are used in different regions of the world. Global system for mobile (GSM) communication networks operate in four different frequency ranges. Most GSM networks operate in the 900 MHz or 1800 MHz bands, but some countries in the Americas (including Canada and the United States) use the 850 MHz and 1900 MHz bands because the 900 and 1800 MHz frequency bands were already allocated.

However, as the PIFA is limited by the space within the mobile communication terminal this results in limited antenna frequency characteristics and therefore the usual PIFA is designed to maximize the frequency for only one of the frequency bandwidths required.

Embodiments of the present invention provide a PIFA device and a method for controlling the PIFA device that can satisfy the characteristics of various frequencies in a multi-frequency environment in a mobile communication terminal, without compromising performance in terms of high signal transmission strength, good reception of weak signals, and the limited dimensions.

### SUMMARY OF THE INVENTION

To cover several transmission frequencies, for example, both GSM 850 and 900 (Bandwidth at −6 dB S11), the resonance of the Low Band can switch between different frequencies, for example, GSM 850 and 900, by changing the length of the ground plane from an antenna point of view with a microstrip having the dimensions, a×b, on the antenna ground clearance area. This may occur without affecting the high frequency bands.

Embodiments of the invention use an antenna including: a ground plane, a feed element, and a radiating element that couples to the feed element, the radiating element being substantially parallel to and vertically displaced from the ground plane by the feed element and a shortening element. The antenna may also include a conductive portion that may couple to the ground plane by means of a switching element, the conductive portion being configured to alter size of said ground plane. The conductive portion may be, for example, a microstrip. According to one embodiment, the conductive portion may be arranged at a ground clearance area. The conductive portion may be configured to change the resonance frequency of the antenna. In one embodiment, the conductive portion may be configured, when coupled to the ground plane, to shift resonance of the antenna to a lower frequency.

Embodiments of the invention also relate to a wireless communication device having an antenna that includes: a ground plane, a feed element, and a radiating element coupled to the feed element, the radiating element being substantially parallel to and vertically displaced from the ground plane by the feed element and a shortening element. The antenna may also include a conductive portion that may couple to the ground plane by means of a switching element, the conductive portion being configured to alter size of the ground plane.

Embodiments of the invention may also relate to a method of controlling an antenna in a wireless communication device. The antenna may include: a ground plane, a feed element, and a radiating element that may couple to the feed element, the radiating element being substantially parallel to and vertically displaced from the ground plane by the feed element, a shortening element, and a conductive portion that may couple to the ground plane by means of a switching element, the conductive portion being configured to alter size of said ground plane. The method may include coupling the conductive portion to the ground plane by the switching element to change the resonance of the ground plane and thereby operation frequency of the antenna.

### BRIEF DESCRIPTION OF THE DRAWINGS

The accompanying drawings, which are incorporated in and constitute a part of this specification, illustrate an embodiment of the invention and, together with the description, explain the invention. In the drawings:

FIG. 1 illustrates a block diagram of a wireless communication device according to the present invention;

FIG. 2 illustrates a conventional PIFA design;

FIG. 3 illustrates a PIFA according to the invention;

FIG. 4 illustrates a block diagram of a wireless communication device according to the invention;

FIG. 5 illustrates an operation flowchart for receiving current location information from the user or BS and changing a frequency band based on the location information;

FIG. 6 illustrates the reflection coefficients of the antenna according to the invention with respect to frequency; and

FIG. 7 illustrates a cross section through part of PCB and parasitic element according to the invention.

### DETAILED DESCRIPTION OF PREFERRED EMBODIMENTS

Exemplary antenna designs described in the following description may be “planar” antennae. A “planar” antenna may have an extended shape that lies generally along a plane, i.e., the antenna may have three dimensions but one of the dimensions may be an order of a magnitude less than the other two dimensions.

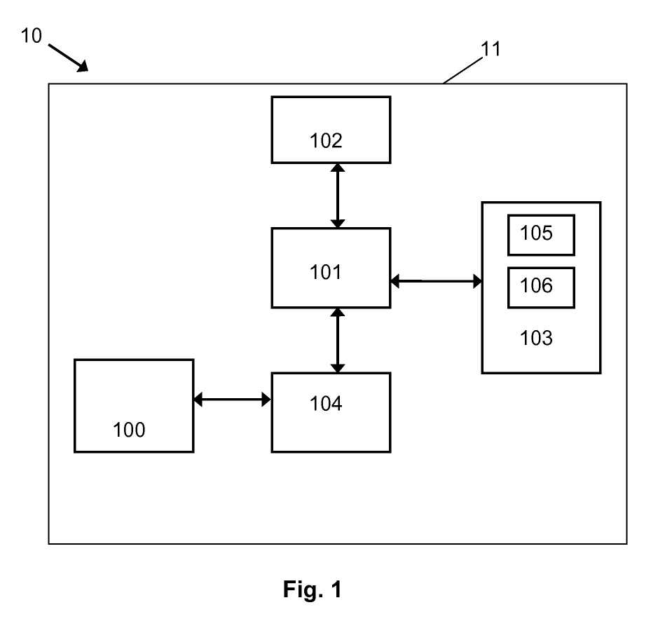

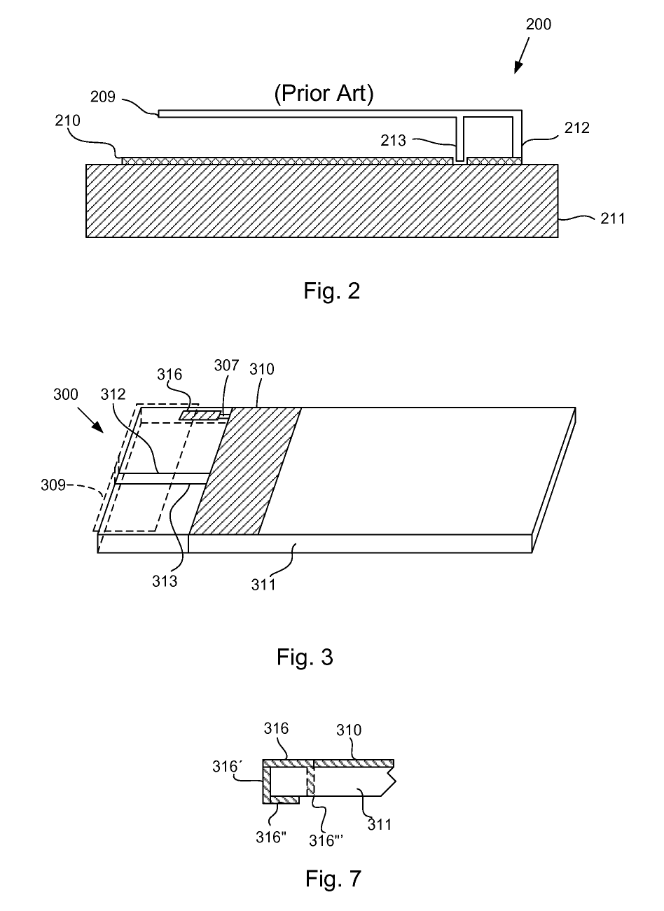

FIG. 1 illustrates a block diagram of an exemplary wireless communication device 10. Wireless communication device 10 may include a housing 11, a controller 101, a memory 102, a user interface 103, a transceiver 104, a key input unit 105, a display unit 106, and a multiband antenna 100. Transceiver 104 may interface wireless communication device 10 with a wireless network using antenna 100. It is appreciated that transceiver 104 may transmit or receive signals according to one or more of any known wireless communication standards known to the person skilled in the art. Controller 101 may control the operation of wireless communication device 10 responsive to programs stored in memory 102 and instructions provided by the user via interface 103.

Embodiments of the PIFA design according to the present invention allows the antenna to be tuned to the desired operating resonance frequency or resonance frequencies required, while not compromising the antenna size or the operation of the other frequency bands.

For purposes of illustration, the following describes antenna 100 in terms of a low frequency wireless communication band and a high frequency band, wherein a switch between, for example, 850 MHz and 900 MHz, within the low GSM frequency band, and a switch between, for example, 1800 MHz and 1900 MHz within the GSM high frequency band, will take place. However, it will be appreciated that antenna 100 may be designed to cover additional or alternative wireless communication frequency bands.

FIG. 3 discloses a PIFA according to the present invention. PIFA 300 may include a ground plane 310 formed on a substrate 311. In one embodiment, ground plane 310 may be embedded directly on substrate 311 (i.e., a PCB), which also may carry other electrical components of the device. This provides the advantage that the antenna can be mounted relatively close to the PCB, thus saving volume in the wireless device. PIFA 300 may also include a radiating element 309, which may include a low frequency radiating element and a high frequency radiating element, respectively. Radiating element 309 may comprise any known configuration or pattern and vary in size to optimize the bandwidth, operating frequency, radiation patterns, and the like. Radiating element 309 may electrically connect to ground plane 310 via a tuning or shortening element 312. Feed element 313 may connect a signal source from a radio or other RF transmitter, receiver, or transceiver (not shown) to radiating element 309. In one embodiment, feed element 313 may be at least partially electrically insulated from ground plane 310 to prevent grounding therefrom.

To cover both, for example, GSM 850 and GSM 900 (Bandwidth at −6 dB S11), the resonance of the low band switches between these two bandwidths by changing the size of the ground plane, for example, the length of ground plane 310, from an antenna point of view, with a microstrip 316 with specific dimensions, a×b, which is arranged on the antenna ground clearance and connected to the ground plane by means of switching element 307.

The microstrip antenna according to the invention, which may be a narrowband, wide-beam antenna, may be fabricated by etching the antenna element pattern in metal trace bonded to an insulating dielectric substrate with a continuous metal layer bonded to the substrate which forms a ground plane. Possible microstrip antenna radiator shapes include any regular or irregular shape, such as square, rectangular, circular and elliptical, but any continuous shape is possible. The microstrip antenna may be, for example, a rectangular patch. The rectangular patch antenna may be approximately a one-half wavelength long section of rectangular microstrip transmission line. When air is the antenna substrate, the length of the rectangular microstrip antenna may be approximately one-half of a free-space wavelength. As the antenna is loaded with a dielectric as its substrate, the length of the antenna may decrease as the relative dielectric constant of the substrate increases.

Because of the orientation and location of microstrip 316 relative to feed element 313 and shortening element 312, electromagnetic interaction between feed element 313, shortening element 312, and microstrip 316 may occur when antenna switching element 307 connects microstrip 316 to ground plane 310. This electromagnetic interaction may cause microstrip 316 to capacitively couple feed element 313 to shortening element 312. This coupling may effectively move the feed point between radiating element 309 and ground plane 310 and thereby change the overall electromagnetic impedance of antenna 300. Microstrip 316 may be configured to improve the impedance of antenna 300 in the first frequency band (e.g. 850 MHz) of the low frequency band, but may not impact the impedance of the antenna in the high frequency band. Thereafter, by disconnecting microstrip 316 from ground plane 310 when the antenna is to operate in the second frequency band (e.g. 900 MHz), antenna switching element 307 may selectively remove the electromagnetic coupling between microstrip 316 and ground plane 310, and enable normal antenna operation in the second frequency band, also now without affecting the higher frequency band.

If the size (e.g., length and width) of the microstrip is not sufficient, it is also possible to continue with the microstrip to the other side of the PCB or a suitable direction. This is illustrated in FIG. 7, where 316′ and 316″ denote extension of the parasitic element 316 over the edge and the other side, respectively, of PCB 311. Parasitic element 316′″ may also extend through a via. Additional switches may be arranged to connect several microstrips and alter the total size of the microstrip.

Antenna switching element 307 may selectively control the electromagnetic coupling by selectively controlling the connection between microstrip 316 and ground plane 310. This connection may be controlled using any means that creates an impedance connection when the antenna is required to switch between two frequencies within the low frequency band. Antenna switching element 307 may be controlled by a controller 301. Closing switching element 307 may create an impedance connection. Switching element 307 may be any of a mechanical or electrical element such as a MOS or CMOS transistor, etc.

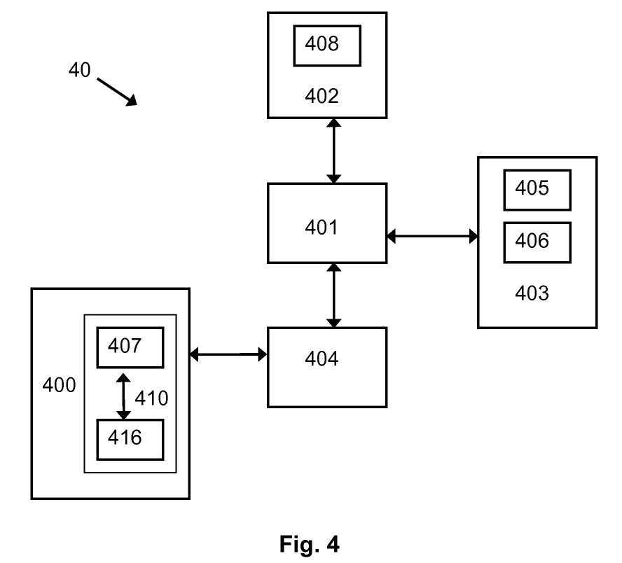

FIG. 4 is a block diagram illustrating a structure of a mobile communication terminal 40 in accordance with an embodiment of the present invention. Referring to FIG. 4, mobile communication terminal 40 may include a memory 402, a key input unit 405, a display unit 406, a transceiver 404, a PIFA 400, an antenna switch element 407, and a controller 401. Controller 401 may process voice signals and/or data according to the protocol for a phone call, data communication, or wireless Internet access, and may control the respective components of mobile communication terminal 40. Controller 401 may also receive key input from key input unit 405, and control display unit 406 to generate and provide image information in response to the key input. Controller 401 may receive current location information from the user or BS. Through the received location information, controller 401 may identify a frequency band mapped to the current location from a region frequency memory 408 included in memory 402. Controller 401 may determine if a frequency band change is desired. When the frequency band change is desired, controller 401 may control antenna switching element 407 to selectively connect or disconnect a microstrip 416 from ground plane 410.

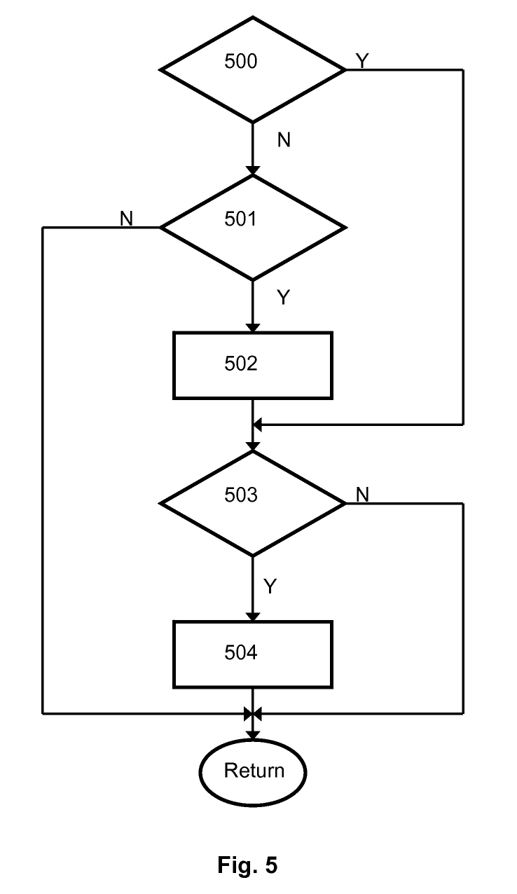

FIG. 5 is a flowchart illustrating an exemplary operation for receiving current location information from the user or BS and changing a frequency band based on the location information. Referring to the structure in FIG. 4, controller 401 of mobile communication terminal 40 proceeds to step 500 to determine if location information has been input from the user. If location information has been input from the user, controller 401 proceeds to step 503. In step 503, controller 401 may load information about a frequency band of a region corresponding to the location information input by the user from region frequency memory 408 of memory 402 and determine if a frequency band change is desired.

If location information is absent, controller 401 proceeds to step 501 to determine if a roaming service is activated. If the roaming service has not been activated, controller 401 may determine that a frequency band change according to the current location is not required.

However, if the roaming service has been activated as a result of the determination in step 501, controller 401 proceeds to step 502 to receive location information about the current region from the BS of a cell in which the current roaming service has been activated. Then, controller 401 proceeds to step 504 to control antenna switching element 407 and selectively connect or disconnect microstrip 416 from ground plane 410 according to the located frequency band.

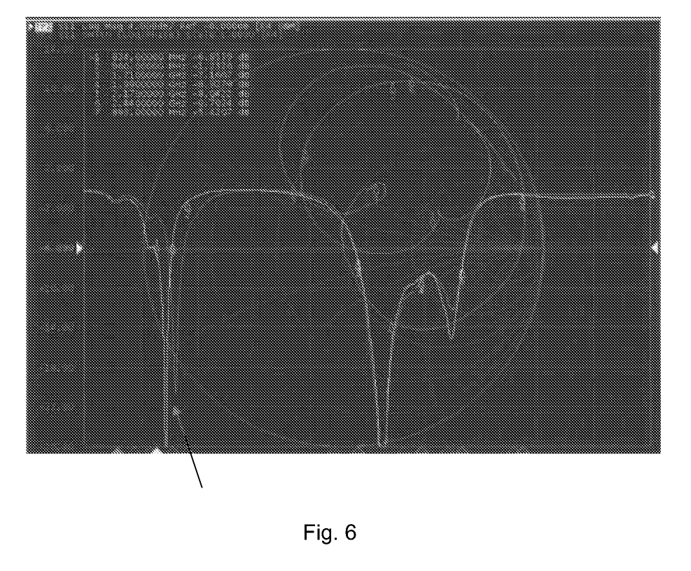

Curves (1) and (2) in FIG. 6 illustrate the reflection coefficients of antenna 402 with respect to frequency when microstrip 416 is not connected to ground plane 410. Curve (1) resonates at frequency 900 MHz and (2) at 1900 MHz. Curves (3) and (4) illustrate the reflection coefficients with respect to frequency when microstrip 409 is connected to ground plane 410. Here curve (3) shows the resonation at 850 MHz and (604) at 1800 MHz frequency. The size of microstrip 416 used in this example is 4×7 mm. As shown by the reflection curves (1) and (3), using microstrip 416 to capacitively couple microstrip 416 to ground plane (410) induces a 40 MHz frequency shift (pointed out with arrow) in the low frequency band from about 900 MHz to about 850 MHz. The curves in the high frequency band are virtually unaffected.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

What we claim is:

1. An antenna comprising:
a ground plane;
a feed element;
a radiating element coupled to the feed element, the radiating element being substantially parallel to and vertically displaced from the ground plane by the feed element and a shortening element; and
a conductive portion coupled to the ground plane using a switching element, the conductive portion being configured to alter size of the ground plane.

2. The antenna of claim 1, wherein the conductive portion comprises a microstrip.

3. The antenna of claim 1, wherein the conductive portion is arranged at a ground clearance area.

4. The antenna of claim 1, wherein the conductive portion is configured to change the resonance frequency of the antenna.

5. The antenna of claim 1, wherein the conductive portion is configured to, when coupled to said ground plane, shift resonance of the antenna to a lower frequency.

6. An antenna for a wireless communication device, the antenna comprising:
a ground plane;
a feed element;
a radiating element coupled to the feed element, the radiating element being substantially parallel to and vertically displaced from the ground plane by the feed element and a shortening element; and
a conductive portion coupled to the ground plane using a switching element, the conductive portion being configured to alter size of the ground plane.

7. A method of controlling an antenna in a wireless communication device, the antenna including: a ground plane, a feed element, and a radiating element coupled to the feed element, the radiating element being substantially parallel to and vertically displaced from the ground plane by the feed element, a shortening element, and a conductive portion coupled to the ground plane using a switching element, the conductive portion being configured to alter size of the ground plane, the method comprising:
coupling the conductive portion to the ground plane by the switching element to change the resonance of the ground plane and thereby operation frequency of the antenna.
